(19) United States
(12) Patent Application Publication
(10) Pub. No.: US 2007/0189011 A1
(43) Pub. Date: Aug. 16, 2007

(54) LIGHT-GENERATING MODULE, BACKLIGHT ASSEMBLY AND DISPLAY DEVICE HAVING THE SAME, AND METHOD THEREOF

(75) Inventors: Chun-Ho SONG, Seoul (KR); Young-Keun LEE, Suwon-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/674,456

(22) Filed: Feb. 13, 2007

(30) Foreign Application Priority Data
Feb. 14, 2006 (KR) 10-2006-0014038

(51) Int. Cl. F21V 29/00

(52) U.S. Cl. 362/294

(57) ABSTRACT

A light-generating module includes a heat radiating plate, a first insulation layer, a conductive pattern, and a plurality of light sources. The heat radiating plate includes graphite. The first insulation layer is formed on a first surface of the heat radiating plate. The conductive pattern is formed on the first insulation layer. The light sources are mounted on the conductive pattern. Therefore, reducing an efficiency of a light emitting diode (“LED”) due to exposure of a high temperature is prevented, so that a luminance of light emitting from a backlight assembly and a display quality of a display device are enhanced.

This application claims priority to Korean Patent Application No. 2006-14038, filed on Feb. 14, 2006 and all the benefits accruing therefrom under 35 U.S.C. §119, and the contents of which in its entirety are herein incorporated by reference.

### BACKGROUND OF THE INVENTION

1. Field of the Invention

The present invention relates to a light-generating module, a backlight assembly, a display device having the backlight assembly, and a method thereof. More particularly, the present invention relates to a light-generating module for preventing a heat point that is generated in a peripheral area of a point light source by enhancing heat radiation, a backlight assembly having the light-generating module, a display device having the light-generating module, and a method of enhancing heat radiation in a light-generating module.

2. Description of the Related Art

A liquid crystal display (“LCD”) device includes a backlight assembly that provides a display panel in the LCD with light in order to display an image in a dark place. Recently, an effort for enhancing the luminosity and a luminance uniformity of light exiting from the backlight assembly has progressed with the intention of decreasing the power consumption of the LCD device and enhancing a display quality.

Backlight assemblies of the LCD device are mainly classified into a direct downward type and an edge type in accordance with the disposal of the light source. The direct downward type backlight assembly includes a plurality of light sources that are disposed below the display panel. The edge type backlight assembly includes a light guide plate (“LGP”) and a light source disposed at the side of the LGP.

The light source includes a cold cathode fluorescent lamp (“CCFL”), a light emitting diode (“LED”), etc. Power consumption of the LED has been low and a size and weight of the LED is small and light, therefore the LED has become widely used as the light source of the LCD device.

When the LED is used in the backlight assembly, the color and luminance uniformity of light exiting the backlight assembly are excellent. Additionally, the size and thickness of the backlight assembly can lessen.

However, heat is generated from the LED when light exits the LED and the backlight assembly. When the heat generated from the LED cannot radiate toward the exterior fast enough, the temperature of the LED's peripheral area increases to more than 70° C. Thus the durability of the LED and its luminosity decrease, and its color coordinate is varied. Consequently, the display quality of the display device is decreased.

In order to radiate the heat, the substrate on which the LED is mounted includes a layer of aluminum Al, a material that has high thermal conductivity. However, the aluminum Al layer has the same thermal conductivities of about 200 kcal/m° C. in all directions, so that preventing the efficiency reduction of the LED due to the generated heat is insufficient.

### BRIEF SUMMARY OF THE INVENTION

The present invention provides a light-generating module having a heat radiating plate including graphite, which includes an insulating layer and a conductive pattern on which the point light source is mounted to prevent an efficiency of the point light source from reducing due to heat.

The present invention also provides a backlight assembly having the above-mentioned light-generating module to enhance luminosity of an emitting light from the light-generating module.

The present invention also provides a display device having the above-mentioned light-generating module.

The present invention also provides a method of enhancing heat radiation from the light-generating module.

In exemplary embodiments of the present invention, the light-generating module includes a heat radiating plate, a first insulation layer, a conductive pattern and a plurality of light sources. The heat radiating plate includes graphite. The first insulation layer is formed on a first surface of the heat radiating plate. The conductive pattern is formed on the first insulation layer. The light sources are mounted on the conductive pattern.

Preferably, the heat radiating plate has a first thermal conductivity in a perpendicular direction of the heat radiating plate and a second thermal conductivity that is greater than the first thermal conductivity in a horizontal direction of the heat radiating plate. The light-generating module may further include a second insulation layer. The second insulation layer covers the conductive pattern to electrically insulate the conductive pattern from an external side. The light-generating module may further include a light-reflecting layer. The light-reflecting layer is formed upon the second insulation layer and opened in areas corresponding to the light sources.

In another exemplary embodiment of the present invention, the backlight assembly includes a receiving container, a light-generating module, and an optical unit. The light-generating module is disposed in the receiving container. The light-generating module includes a heat radiating plate including graphite, a first insulation layer formed on a first surface of the heat radiating plate, a conductive pattern formed on the first insulation layer, and a plurality of light emitting diodes (“LEDs”) mounted on the conductive pattern. The optical unit enhances optical characteristics of an emitting light emitted from the LEDs, and outputs enhanced light.

For example, the backlight assembly may further include an adhesive member. The adhesive member attaches the heat radiating plate to a base plate of the receiving container. The backlight assembly may further include a reflecting sheet having a plurality of openings corresponding to the LEDs, which is disposed on the second insulation layer. The optical unit is spaced apart from the LEDs.

In a backlight assembly according to another exemplary embodiment, the optical unit includes an exiting surface, an opposite surface, and a side surface. The opposite surface is opposite to the exiting surface. The opposite surface is disposed on a base plate of the receiving container. The side surface connects the exiting surface to the opposite surface, and receives an emitting light from the LEDs.

The light-generating module includes a first insulation layer, a conductive pattern, a second insulation layer, and a plurality of LEDs. The first insulation layer is formed on the heat radiating plate. The conductive pattern is formed on the first insulation layer and receives a driving current from an external device. The second insulation layer covers the conductive pattern. The LEDs are mounted on the conductive pattern that is exposed through the second insulation layer.

Preferably, the heat radiating plate includes a first surface, a second surface, and a third surface. The first surface corresponds to the LEDs that are disposed thereon. The second surface is extended from the first surface. The second surface covers a portion of the exiting surface of the optical unit. The third surface is extended from the first surface and faces the second surface. The third surface covers a portion of the opposite surface of the optical unit.

In still other exemplary embodiments of the present invention, the display device includes a receiving container, a light-generating module, an optical unit, and a display panel. The receiving container includes a base plate and a plurality of sidewalls disposed at a peripheral area of the base plate to form a receiving space. The light-generating module is disposed in the receiving container. The optical unit enhances optical characteristics of an emitting light from the LEDs and outputs enhanced light. The display panel displays an image based on the enhanced light emitted from the optical unit. The light-generating module includes a heat radiating plate, a first insulation layer, a conductive pattern, a second insulation layer, and a plurality of LEDs. The heat radiating plate includes graphite. The first insulation layer is formed on the heat radiating plate. The conductive pattern is formed on the first insulation layer and receives a driving current from an external device. The second insulation layer covers the conductive pattern. The LEDs are mounted on the conductive pattern that is exposed through the second insulation layer.

In still other exemplary embodiments of the present invention, a method of enhancing heat radiation from a light generating module of a display device includes mounting a light source of the light generating module on a heat radiating plate, the light source emitting light on a light incident surface of an optical unit of the display device, providing a portion of the heat radiating plate parallel to the light incident surface with a first thermal conductivity in a direction perpendicular to the light incident surface of the optical unit, and providing the portion of the heat radiating plate parallel to the light incident surface with a second thermal conductivity in a direction parallel to the light incident surface of the optical unit, wherein the second thermal conductivity is substantially greater than the first thermal conductivity.

The heat radiating plate may include graphite and the light source may include an LED. The second thermal conductivity may be about 40 times greater than the first thermal conductivity.

According to the light-generating module, the backlight assembly and the display device having the backlight assembly, and the method of enhancing heat radiation in the light-generating module, efficiency decrease in the LED is prevented due to the exposure of a high temperature, so that luminosity of the emitting light from the backlight assembly and a display quality of the display device are enhanced.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a plan view illustrating an exemplary light-generating module according to an exemplary embodiment of the present invention;

FIG. 2 is a cross-sectional view taken along line I-I′ of FIG. 1;

FIG. 3 is a cross-sectional view illustrating an exemplary portion of an exemplary light-generating module according to another exemplary embodiment of the present invention;

FIG. 4 is an exploded perspective view illustrating an exemplary backlight assembly according to an exemplary embodiment of the present invention;

FIG. 5 is a cross-sectional view taken along line II-II′ of the exemplary backlight assembly shown in FIG. 4;

FIG. 6 is an enlarged view of portion A of FIG. 5;

FIG. 7 is a graph showing the temperature of a peripheral area of the exemplary point light sources shown in FIG. 4 and of a comparative example;

FIG. 8 is an exploded perspective view illustrating an exemplary backlight assembly according to another exemplary embodiment of the present invention;

FIG. 9 is a cross-sectional view taken along line III-III′ of the exemplary backlight assembly shown in FIG. 8;

FIG. 10 is a cross-sectional view illustrating a portion of an exemplary display device according to an exemplary embodiment of the present invention; and

FIG. 11 is a cross-sectional view illustrating a portion of an exemplary display device according to another exemplary embodiment of the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

Light-Generating Module

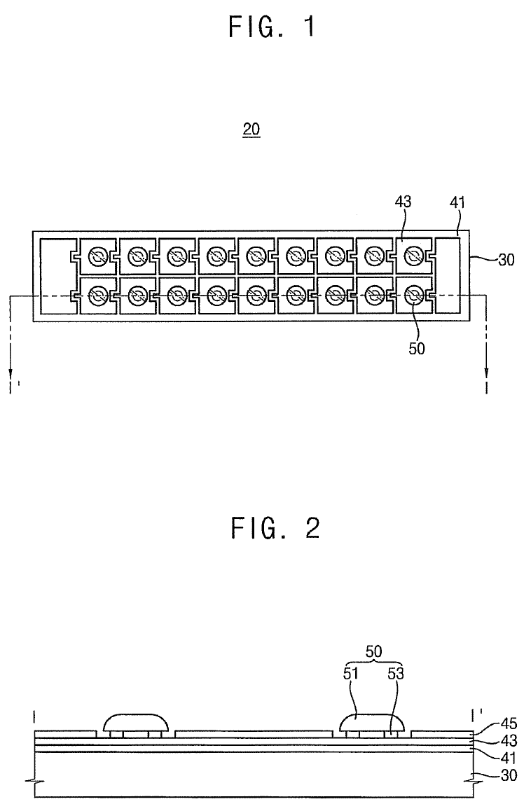

FIG. 1 is a plan view illustrating an exemplary light-generating module according to an exemplary embodiment of the present invention. FIG. 2 is a cross-sectional view taken along line I-I′ of FIG. 1.

Referring to FIGS. 1 and 2, a light-generating module 20 according to an exemplary embodiment of the present invention includes a heat radiating plate 30, a first insulation layer 41, a conductive pattern 43, and a plurality of point light sources 50.

The heat radiating plate 30 may include graphite. The heat radiating plate 30 may have a rectangular-shape, although other shapes would also be within the scope of these embodiments. The heat radiating plate 30 has a first thermal conductivity in a perpendicular direction, where the perpendicular direction is a first direction perpendicular to a top surface layer of the heat radiating plate 30. The heat radiating plate 30 also has a second thermal conductivity that is greater than the first thermal conductivity in a horizontal direction, where the horizontal direction is a second direction perpendicular to the first direction and parallel to a top surface layer of the heat radiating plate 30.

The heat radiating plate 30 includes pure carbon. The majority of the carbon includes a hexagonal system crystal structure, and the remaining of the carbon includes a trigonal system crystal structure. The carbon is coupled to each other with a hexagon-shape such as benzene nucleus. The hexagon-shape defines a plate-shaped member, and is formed in a horizontal direction. Three electrons of the carbon atom are bonded to each other via a covalent bond, and the remaining electron thereof is bonded to an upper layer of the carbon atom or a lower layer thereof.

The height of the hexagon-shape is about 3.40 Å, and the distance between the adjacent carbons of the hexagon-shape is about 1.42 Å. A distance between the upper and lower layers of the plate-shaped member is greater than a distance between two adjacent carbon atoms. Therefore, an electron existing on an upper portion in the plate-shaped member is able to move, so that the graphite has a high electric conductivity and a high thermal conductivity.

A plurality of the plate-shaped members is laminated, so that the heat radiating plate 30 has different heat conductivities and electric conductivities depending on directions. In detail, an electric resistance according to a perpendicular direction of the plate-shaped member is greater than an electric resistance of the horizontal direction by approximately 100 times, and the thermal conductivity according to a horizontal direction is greater than the thermal conductivity of a perpendicular direction by approximately 40 times.

In the exemplary embodiment of the present invention, the heat radiating plate 30 has the first thermal conductivity of about 10 kcal/m° C. in a perpendicular direction of the heat radiating plate 30, and has the second thermal conductivity of about 400 kcal/m° C. to about 420 kcal/m° C. in a horizontal direction.

The first insulation layer 41 is electrically insulated between the heat radiating plate 30 and the conductive pattern 43. The first insulation layer 41 includes, for example, a resin. For example, the first insulation layer 41 is coated on a first surface of the heat radiating plate 30. For another example, the first insulation layer 41 is suppressed on a first surface of the heat radiating plate 30.

The conductive pattern 43 is formed on the first insulation layer 41. For example, the conductive pattern 43 is formed through a process including depositing a copper film on the first insulation layer 41, and patterning the copper film. The conductive pattern 43 includes a conductive wiring supplying a driving current to the point light source 50, and a pad portion receiving the driving current from an external device (not shown).

The light-generating module 20 may further include a second insulation layer 45. The second insulation layer 45 covers the conductive pattern 43 except for connection areas having each having a terminal 53 of a point light source 50 disposed thereon, and electrically insulates the conductive pattern 43 from an external side of the light-generating module 20.

The point light sources 50 are mounted on the conductive pattern 43 that is exposed by the connection areas. The point light source 50 includes a light emitting diode (“LED”). The LED includes a light emitting member 51 and a terminal 53. The terminal 53 is electrically connected to the conductive pattern 43, and receives the driving current.

The light emitting member 51, a so-called semiconductor, exits light in response to receiving the driving current from the terminal 53. A large amount of heat is generated when the LED 50 exits the lights, and the generated heat is transferred to the heat radiating plate 30 through a thermal radiation method and a thermal conduction method via the terminal 53.

When the light-generating module 20 is applied to a backlight source of a display device, the heat radiating plate 30 may be disposed at a base plate or side-walls of a receiving container, depending on the type of backlight assembly used in the display device. Hence, a heat that is transferred from the heat radiating plate 30 to the base plate or the side-walls is transferred in the perpendicular direction with a first thermal conductivity, however heat that is transferred to the heat radiating plate 30 is transferred in the horizontal direction with a second thermal conductivity that is greater than the first thermal conductivity by approximately 40 times.

Therefore, the heat transferred to the heat radiating plate 30 is not accumulated in one spot of the radiating plate 30, and is quickly transferred to the entire heat radiating plate 30. Thus, the heat radiating plate 30 decreases a thermal deviation that is generated between one portion on which the point light source 50 is mounted and another portion on which the point light source 50 is not mounted. Consequently, a heat point is prevented from occurring in the peripheral area of the point light source 50, so that a light emitting efficiency of the point light source 50 is increased.

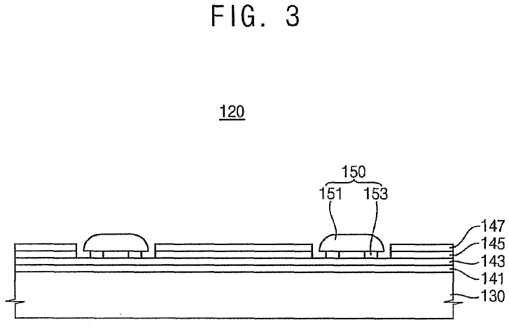

FIG. 3 is a cross-sectional view illustrating a portion of an exemplary light-generating module according to another exemplary embodiment of the present invention.

Referring to FIG. 3, a light-generating module 120 according to another exemplary embodiment of the present invention includes a heat radiating plate 130, a first insulation layer 141, a conductive pattern 143, a second insulating layer 145, a plurality of point light sources 150, and a light-reflecting layer 147. The point light sources 150 may be LEDs, and may include a light-emitting member 151 and a terminal 153 connecting to the conductive pattern 143. The light-generating module 120 of this exemplary embodiment of the present invention is substantially the same as the light-generating module in FIGS. 1 and 2 except for the light-reflecting layer 147. Thus, any further explanation concerning the above elements will be omitted.

The light-reflecting layer 147 may include a material having a high reflecting ratio such as aluminum Al, which is formed on the second insulation layer 145 except an area having the point light source 150 disposed thereon.

The light-reflecting layer 147 re-reflects a directly incidented light and a reflected light in a direction of an upper side of the light-generating module 120. The directly incidented light is exited from the light-emitting member 151 of the point light source 150. The reflected light is reflected by an optical unit, as will be further described below. Also, the light-reflecting layer 147 prevents a heat point from occurring in the second insulation layer 145 of the light-generating module 120.

Backlight Assembly

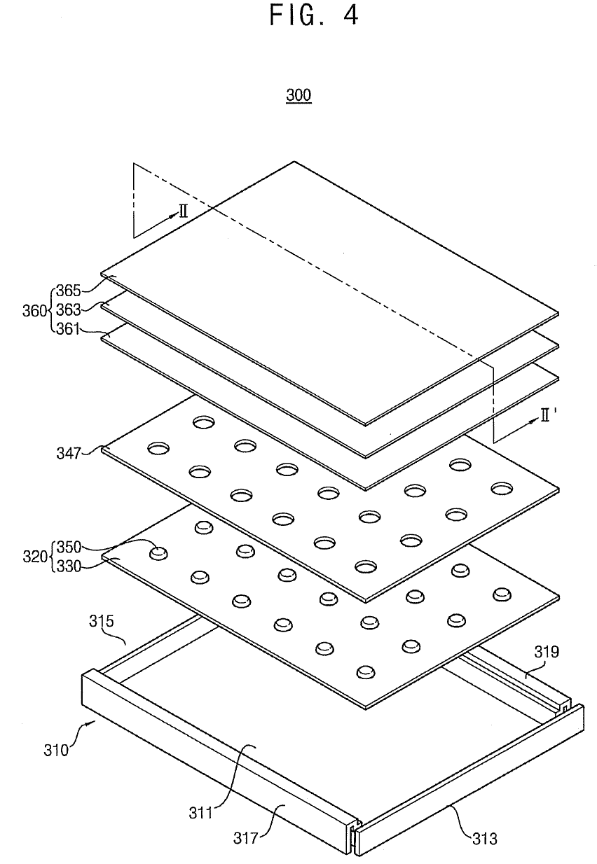

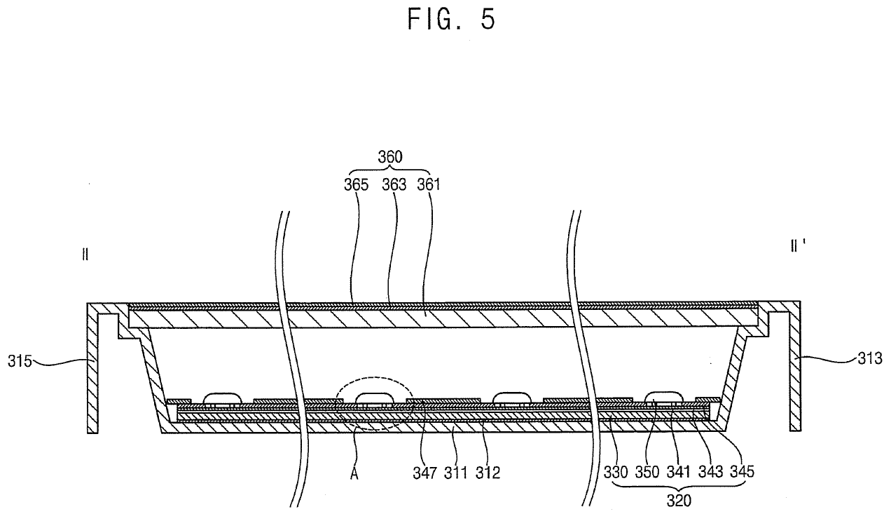

FIG. 4 is an exploded perspective view illustrating an exemplary backlight assembly according to an exemplary embodiment of the present invention. FIG. 5 is a cross-sectional view taken along line II-II′ of the exemplary backlight assembly shown in FIG. 4.

Referring to FIGS. 4 and 5, the backlight assembly 300 includes a receiving container 310, a light-generating module 320, and an optical unit 360.

The receiving container 310 includes a base plate 311 and a plurality of sidewalls that are disposed at a peripheral area of the base plate 311. The sidewalls include a first sidewall 313, a second sidewall 315, a third sidewall 317, and a fourth sidewall 319. The first and second sidewalls 313 and 315 are opposite to each other. The third and fourth sidewalls 317 and 319 are opposite to each other and connected to the first and second sidewalls 313 and 315. A stepped portion is formed upon the first through fourth sidewalls 313, 315, 317, and 319. The receiving container 310 may include a metal material having a high thermal conductivity.

The light-generating module 320 is disposed on the base plate 311, and exits a light toward a front portion of the receiving container 310. The light-generating module 320 includes a heat radiating plate 330, a first insulation layer 341, a conductive pattern 343, a second insulation layer 345, and a plurality of point light sources such as LEDs 350. The light-generating module 320 is substantially the same as the light-generating module 20 as shown in FIGS. 1 and 2 except for the size of the light-generating module corresponding to the base plate 311. Thus, any further explanation concerning the above elements will be omitted.

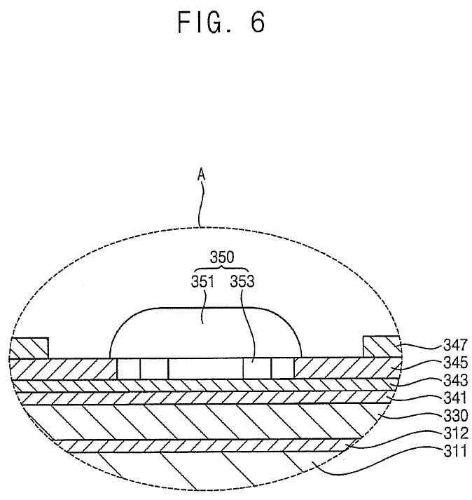

FIG. 6 is an enlarged view of portion A of FIG. 5.

Referring to FIGS. 5 and 6, the backlight assembly 300 may further include an adhesive member 312 and a reflective sheet 347.

The adhesive member 312 is attached to the base plate 311. For example, the adhesive member 312 may include an adhesive double side tape. Preferably, the adhesive double side tape includes a high thermal conductivity material. The adhesive member 312, the heat radiating plate 330, the first insulation layer 341, the conductive pattern 343, and the second insulation layer 345 are arranged as shown in FIG. 6.

The heat generated during the heat radiation is transferred to the heat radiating plate 330 through a thermal radiation method and a thermal conduction method. The heat radiating plate 330 has a first thermal conductivity in a perpendicular direction of the heat radiating plate 330, and has a second thermal conductivity, which is greater than the first thermal conductivity, in a horizontal direction of the heat radiating plate 330. Here, the second thermal conductivity is greater than the first thermal conductivity by approximately 40 times. Therefore, a portion of the transferred heat to the heat radiating plate 330 is transferred to the base plate 311 in the perpendicular direction with the first thermal conductivity, and also radiates to an external side. However, the remaining portion of the transferred heat to the heat radiating plate 330 is quickly transferred in the horizontal direction with the second thermal conductivity. Thus, a temperature of the heat radiating plate 330 is relatively uniform.

The reflecting sheet 347 reflects a light exited from the LEDs 350 and re-cycles light from the light-generating module 320. The reflecting sheet 347 is disposed upon the second insulation layer 345 of the light-generating module 320. A plurality of opening portions corresponding to the LEDs 350 are formed in the reflecting sheet 347, so that the LEDs 350 are exposed through the opening portions, respectively. The LEDs 350 may include a light-emitting member 351 and a terminal 353 connecting to the conductive pattern 343.

The optical unit 360 is supported by stepped portions that are formed in the first to fourth sidewalls 313, 315, 317, 319, and enhances optical characteristics of the light that is exited from the LEDs 350. The optical unit 360 may include a diffusing plate 361 and two prism sheets 363 and 365 that are disposed on the diffusing plate 361.

The diffusing plate 361 diffuses lights exited from the LEDs 350 to enhance a uniformity of the luminance of the light emitting from the LEDs 350. Each of the two prism sheets 363 and 365 converges lights that are exited from the diffusing plate 361 into a perpendicular direction of the optical unit 360. The backlight assembly 300 may further include a diffusing sheet that is disposed between the diffusing plate 361 and the two prism sheets 363 and 365.

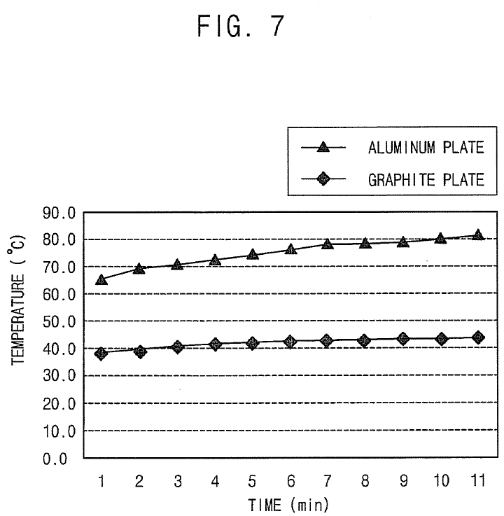

FIG. 7 is a graph showing a temperature of a peripheral area of the exemplary point light sources shown in FIG. 4 and of a comparative example.

Particularly, after applying a driving current to the LEDs 350, when a temperature of the light-generating module 320 is measured in accordance with time, FIG. 7 is obtained. For example, FIG. 7 shows a relationship between thermal characteristics of the light-generating module 320 having a graphite plate as the heat radiating plate 330 according to an exemplary embodiment, and thermal characteristics of a light-generating module having an aluminum plate according to a comparative embodiment.

The light-generating module according to a comparative embodiment differs from the light-generating module 320 according to an exemplary embodiment in FIGS. 4 to 6 in that the graphite plate is replaced with the aluminum plate.

The aluminum plate has a first thermal conductivity of about 200 kcal/m° C. in a perpendicular direction and a second thermal conductivity of about 200 kcal/m° C. in a horizontal direction. The heat generated from the LEDs 350 is transferred to the aluminum plate, and the transferred heat is transferred with the first and second conductivities of about 200 kcal/m° C. in perpendicular and horizontal directions, respectively. Consequently, the heat generated from the LEDs 350 is transferred to the entire aluminum plate, so that the temperature of the aluminum plate is uniform.

However, the aluminum plate contacts the base plate 311 of the receiving container 310 in the perpendicular direction. Therefore, the transferred heat in the perpendicular direction is affected from a heat transferring characteristic of the receiving container 310. When the heat does not quickly transfer to the exterior of the perpendicular direction, the temperature of the peripheral area of the LEDs 350 arises. Consequently, as shown in FIG. 7, the temperature of the light-generating module according to the comparative embodiment gradually increases from about 65° C. to 82° C.

On the other hand, in the exemplary embodiment of the present invention, the heat radiating plate 330 including graphite, has the first thermal conductivity of about 10 kcal/m° C. in a perpendicular direction of the heat radiating plate 330, and has the second thermal conductivity of about 420 kcal/m° C. in a horizontal direction. Therefore, although heat does not smoothly transfer in a perpendicular direction due to the heat transferring characteristics of the receiving container 310, the heat is quickly transferred to the exterior in the horizontal direction. Consequently, the transferred heat to the heat radiating plate 330 does not accumulate in an area corresponding to the LEDs 350, and is quickly transferred to the entire heat radiating plate 330. Therefore, as shown in FIG. 7, the temperature of the light-generating module according to the exemplary embodiment of the present invention is gradually increased from about 38° C. to about 44° C. Thus, a temperature-increasing ratio of the light-generating module 320 according to the exemplary embodiment of the present invention is less than that of the comparative embodiment.

The greater the temperature of the LEDs 350 is increased, the greater a luminance of the emitting light from the LEDs 350 is decreased. When a driving current of the comparative embodiment and a driving current of the exemplary embodiment are substantially the same, a luminance of the emitting light from the light-generating module of the comparative embodiment is less than a luminance of the emitting light from the light-generating module 320 of the exemplary embodiment.

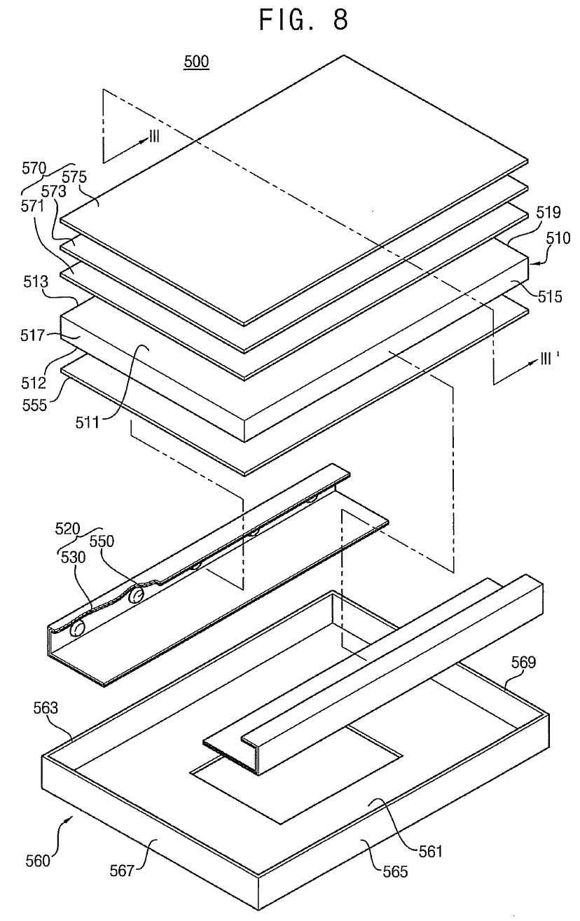

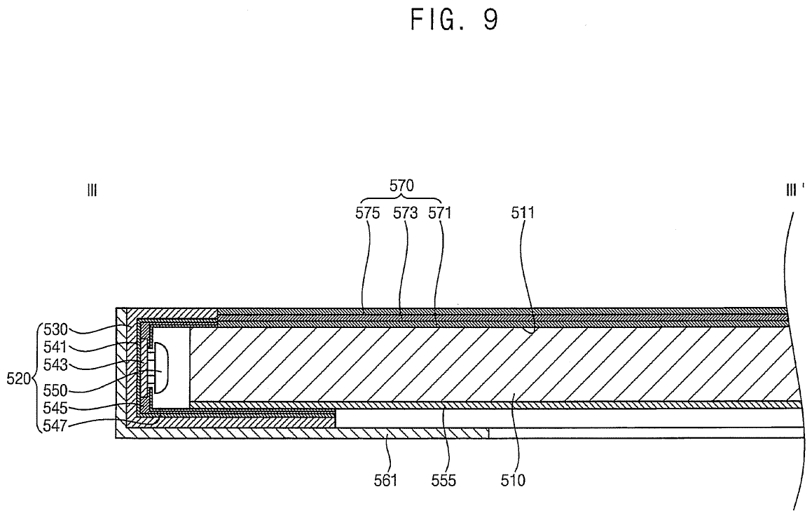

FIG. 8 is an exploded perspective view illustrating an exemplary backlight assembly according to another exemplary embodiment of the present invention. FIG. 9 is a cross-sectional view taken along line III-III′ of the exemplary backlight assembly shown in FIG. 8.

Referring to FIGS. 8 and 9, the backlight assembly 500 includes an optical unit 510, a light-generating module 520, and a receiving container 560.

The optical unit 510 guides a light that is emitted from the light-generating module 520, and then exits the light towards an upward direction. The optical unit 510 includes an exiting surface 511, an opposite surface 512, and a plurality of side surfaces. The side surfaces include a first side surface 513, a second side surface 515, a third side surface 517, and a fourth side surface 519.

The exiting surface 511 and the opposite surface 512 are opposite to each other. The first to fourth side surfaces 513, 515, 517, and 519 connect the exiting surface 511 to the opposite surface 512. The first and second side surfaces 513 and 515 are disposed opposite to each other. The third and fourth side surfaces 517 and 519 are disposed opposite to each other and are connected to the first and second side surfaces 513 and 515.

The optical unit 510 may include a light diffusing-guiding member having a high light transmittance, a high thermal resistance, a high chemical resistance, a high mechanical strength, etc. For example, the light diffusing-guiding member includes polymethylmethacrylate, polyamide, polyimide, polypropylene, polyurethane, etc.

A light-generating module 520 is positioned adjacent the first side surface 513 a light-generating module 520 is positioned adjacent the second side surface 515 of the optical unit 510. Each of the first and second side surfaces 513 and 515 is a light incident surface. The backlight assembly 500 includes two light-generating modules 520 that are disposed at the first side surface 513 and the second-surface 515. The two light-generating modules 520 are substantially the same to each other, so that only a light-generating module 520 that is disposed at the first side surface 513 will be described in detail. In an alternative embodiment, a single light generating module 520 may be placed adjacent one of the side surfaces of the optical unit 510, and the optical unit 510 may taper to an opposite side surface.

The light-generating module 520 may include a heat-radiating plate 530, a first insulation layer 541, a conductive pattern 543, a point light source such as an LED 550, a second insulation layer 545, and a light-reflecting layer 547.

The heat radiating plate 530 may include graphite. The heat radiating plate 530 includes a first surface, a second surface, and a third surface. The first surface of the heat radiating plate 530 is opposite to the first side surface 513 of the optical unit 510 and faces the first side surface 513 of the optical unit 510. The second surface of the heat radiating plate 530 is extended from a top edge of the first surface, and covers a portion of the exiting surface 511 of the optical unit 510. The third surface of the heat radiating plate 530 is extended from a bottom edge of the first surface, faces the second surface of the heat radiating plate 530, and covers a portion of the opposite surface 512. The third surface is extended from the first surface, and is longer than the second surface, so that an end portion corresponding to the first side surface 513 of the optical unit 510 is interposed into the heat radiating plate 530.

The heat radiating plate 530 may have a first thermal conductivity of no more than about 10 kcal/m° C. corresponding to a perpendicular direction of each of the first to third surfaces of the heat radiating plate 530, and has a second thermal conductivity, that is greater than the first thermal conductivity, of about 420 kcal/m° C. corresponding to a horizontal direction of each of the first to third surfaces of the heat radiating plate 530.

The first insulation layer 541 is formed on the first to third surfaces of the heat radiating plate 530, and the conductive pattern 543 is formed on the portion of the first insulation layer 541 that is formed on the first surface of the heat radiating plate 530. The second insulation layer 545 is formed on the conductive pattern 543 and exposes connection areas of the conductive pattern 543.

Each LED 550 includes a light emitting member and a terminal that applies a driving current to the light emitting member. The terminal is electrically connected to the conductive pattern 543 that is exposed in the connecting area. When the light-emitting member receives the driving current via the conductive pattern 543, the LED 550 exits a light to the first side surface 513 of the optical unit 510.

A large amount of heat is generated from the light-emitting member when the LED 550 exits the light, and the generated heat is transferred to the heat radiating plate 530 through a thermal radiation method and a thermal conduction method via the terminal 553. The transferred heat to the heat radiating plate 530 is radiated to an external side with the first thermal conductivity along the perpendicular directions of each of the first to third surfaces and also transferred to the entire heat radiating plate 530 with the second thermal conductivity along horizontal directions of each of the first to third surfaces. Consequently, the transferred heat to the heat radiating plate 530 does not accumulate in one spot of the heat radiating plate 530, and is quickly transferred to the entire heat radiating plate 530. Therefore, the heat radiating plate 530 decreases a thermal deviation that is generated between one portion of the heat radiating plate 530 on which the LED 550 is mounted and another portion of the heat radiating plate 530 on which the LED 550 is not mounted.

The light-reflecting layer 547 of the light-generating module 520 is formed on the second insulation layer 545 corresponding to the first to third surfaces of the heat radiating plate 530. The light-reflecting layer 547 may include a material having a high reflecting ratio such as aluminum Al, which is formed on the second insulation layer 545 except an area having the LED 550 disposed thereon.

The light-reflecting layer 547 reflects a light from the light-emitting member 551 toward the first side surface 513. The light-reflecting layer 547 prevents a heat point from occurring in the second insulation layer 545 adjacent the LED 550.

The receiving container 560 includes a base plate 561, a first sidewall 563, a second sidewall 565, a third sidewall 567, and a fourth sidewall 569. The optical unit 510 is disposed on the base plate 561, and the first to fourth side-walls 563, 565, 567, and 569 are disposed at a peripheral area of the base plate 561 to correspond to the first to fourth side surfaces 513, 515, 517, and 519 of the optical unit 510.

The backlight assembly 500 may further include a reflecting sheet 555 and an optical sheet 570.

The reflecting sheet 555 is disposed between the base plate 561 and the opposite surface 512, and reflects any light leaked through the opposite surface 512. The optical sheet 570 is disposed at the exiting surface 511, and enhances luminance uniformity and front luminance of the light that is exited from the exiting surface 511. The optical sheet 570 may include a diffusing sheet 571 and two prism sheets 573 and 575.

Display Device

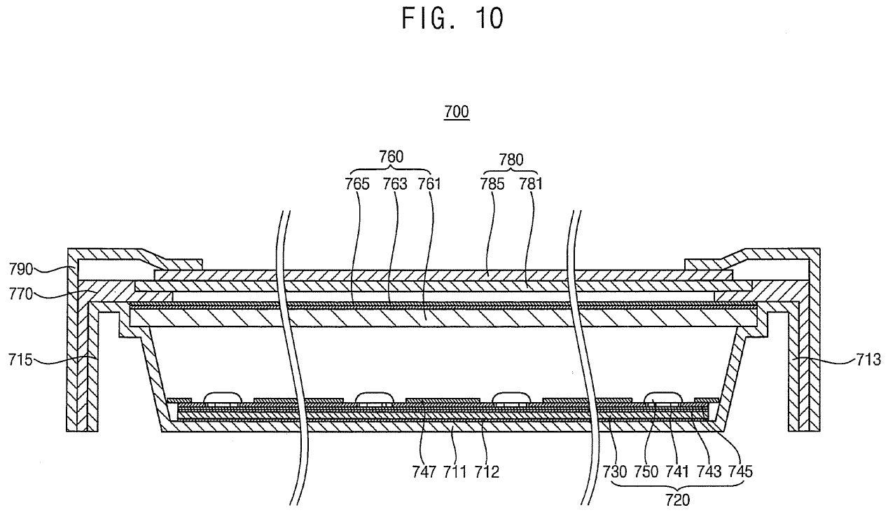

FIG. 10 is a cross-sectional view illustrating a portion of an exemplary display device according to an exemplary embodiment of the present invention.

Referring to FIG. 10, a display device 700 includes a receiving container, a light-generating module 720, an optical unit 760, and a display panel 780.

The receiving container includes a base plate 711 and a plurality of sidewalls including first and second sidewalls 713 and 715, and third and fourth sidewalls (not shown).

The light-generating module 720 includes a heat radiating plate 730, a first insulation layer 741, a conductive pattern 743, a second insulation layer 745, point light sources such as LEDs 750, and a reflective sheet 747. An adhesive member 712 may adhere the heat radiating plate 730 of the light-generating module 720 to the base plate 711 of the receiving container.

The optical unit 760 includes a diffusing plate 761, and prism sheets 763, 765.

The receiving container, the light-generating module 720, and the optical unit 760 are the same as the receiving container 310, the light-generating module 320, and the optical unit 360 in FIGS. 4 to 6, so that any further explanation concerning the above elements will be omitted.

The display panel 780 displays images based on a light that is exited from the LEDs 750 through the optical unit 760. The display panel 780 includes a first substrate 781, a second substrate 785 facing the first substrate 781 and a liquid crystal layer that is disposed between the first and second substrates 781 and 785.

A first electrode is formed in the first substrate 781, and a second electrode facing the first electrode is formed in the second substrate 785. An electric field that is formed by the first and second electrodes transforms an arrangement of a liquid crystal molecule of the liquid crystal layer, so that a transmitting light through the liquid crystal layer is controlled. Therefore, the display device 700 displays images.

The display device 700 may further include a middle mold 770 and a top chassis 790. The middle mold 770 suppresses an end portion of the optical unit 760, and is coupled to the receiving container. The top chassis 790 exposes an effective display area of the display panel 780, and is coupled to the middle mold 770 or the receiving container.

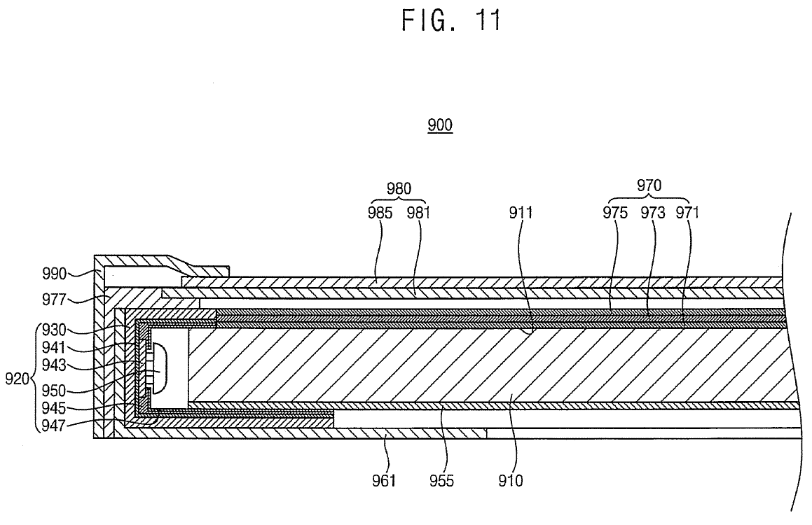

FIG. 11 is a cross-sectional view illustrating a portion of an exemplary display device according to another exemplary embodiment of the present invention.

Referring to FIG. 11, a display device 900 includes an optical unit 910, a light-generating module 920, a receiving container, an optical sheet 970, and a display panel 980.

The optical unit 910 includes a side surface as a light incident surface and a top surface as an exiting surface 911. A reflecting sheet 955 may be disposed on an opposite surface from the exiting surface 911. The light-generating module 920 includes a heat radiating plate 930, a first insulation layer 941, a conductive pattern 943, a point light source such as an LED 950, a second insulation layer 945, and a light-reflecting layer 947. The receiving container includes a base plate 961 and a plurality of sidewalls. The optical sheet 970 includes a diffusing sheet 971 and prism sheets 973, 975. The display panel 980 includes a first substrate 981, a second substrate 985, and a liquid crystal layer interposed there between.

The optical unit 910, the light-generating module 920, the receiving container, and the optical sheet 970 are the same as the optical unit 510, the light-generating module 520, the receiving container 560, and the optical sheet 570 in FIGS. 8 and 9, so that any further explanation concerning the above elements will be omitted. The display panel 980 is the same as the display panel 780, so that any further explanation concerning the above element will be omitted.

The display device 900 may further include a middle mold 977 and a top chassis 990. The middle mold 977 and the top chassis 990 are the same as the middle mold 770 and the top chassis 790 in FIG. 10, so that any further explanation concerning the above elements will be omitted.

In the exemplary embodiment of the present invention, the heat radiating plate 930 has thermal conductivities of different directions, so that a temperature of the light-generating module 920 is maintained within a thermal range that does not decrease the efficiency of the LEDs 950. Therefore, loss of the regular function of the liquid crystal is prevented, which is induced by a heat that is transferred from the light-generating module 920.

In view of the above-described embodiments, a method of enhancing heat radiation from a light generating module of a display device is made possible that includes mounting a light source of the light generating module on a heat radiating plate, the light source emitting light on a light incident surface of an optical unit of the display device, providing a portion of the heat radiating plate parallel to the light incident surface with a first thermal conductivity in a direction perpendicular to the light incident surface of the optical unit, and providing the portion of the heat radiating plate parallel to the light incident surface with a second thermal conductivity in a direction parallel to the light incident surface of the optical unit, wherein the second thermal conductivity is substantially greater than the first thermal conductivity.

According to the present invention, the heat radiating plate has a thermal conductivity in a horizontal direction that is greater than a thermal conductivity in a perpendicular direction. Therefore, heat that is quickly transferred to the heat radiating plate is transferred to the entire heat radiating plate, so that the amount of heat that is emitted to an external side in the perpendicular direction is increased. Moreover, in the light-generating module, a thermal deviation is decreased, which is generated between an area on which the LED is mounted and the remaining area. Additionally, a heat point is prevented from occurring in the peripheral area of the LED, so that a light emitting efficiency of the LED is increased.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A light-generating module comprising:
a heat radiating plate including graphite;
a first insulation layer formed on a first surface of the heat radiating plate;
a conductive pattern formed on the first insulation layer; and
a plurality of light sources mounted on the conductive pattern.

2. The light-generating module of claim 1, wherein the heat radiating plate has a first thermal conductivity in a perpendicular direction of the heat radiating plate and a second thermal conductivity that is greater than the first thermal conductivity in a horizontal direction of the heat radiating plate.

3. The light-generating module of claim 2, wherein the second thermal conductivity is greater than the first thermal conductivity by approximately 40 times.

4. The light-generating module of claim 3, further comprising a second insulation layer covering the conductive pattern to electrically insulate the conductive pattern from an external side.

5. The light-generating module of claim 4, further comprising a light-reflecting layer formed upon the second insulation layer and opened in areas corresponding to the light sources.

6. The light-generating module of claim 5, wherein each light source is a light emitting diode.

7. A backlight assembly comprising:
a receiving container;
a light-generating module disposed in the receiving container, the light-generating module including a heat radiating plate including graphite, a first insulation layer formed on a first surface of the heat radiating plate, a conductive pattern formed on the first insulation layer, and a plurality of light emitting diodes mounted on the conductive pattern; and
an optical unit enhancing optical characteristics of an emitting light emitted from the light emitting diodes, and outputting enhanced light.

8. The backlight assembly of claim 7, further comprising an adhesive member attaching the heat radiating plate to a base plate of the receiving container.

9. The backlight assembly of claim 7, further comprising a reflecting sheet having a plurality of openings corresponding to the light emitting diodes, the reflecting sheet disposed on the second insulation layer.

10. The backlight assembly of claim 9, wherein the optical unit is spaced apart from the light emitting diodes.

11. The backlight assembly of claim 7, wherein the optical unit comprises,
an exiting surface;
an opposite surface opposed to the exiting surface, and disposed on a base plate of the receiving container; and
a side surface connecting the exiting surface to the opposite surface, the side surface receiving the emitting light from the light emitting diodes.

12. The backlight assembly of claim 11, wherein the heat radiating plate comprises,
a first surface corresponding to the light emitting diodes disposed thereon, the first surface facing the side surface of the optical unit;
a second surface extended from the first surface, the second surface covering a portion of the exiting surface of the optical unit; and
a third surface extended from the first surface and facing the second surface, the third surface covering a portion of the opposite surface of the optical unit.

13. The backlight assembly of claim 12, wherein the light-generating module further comprises a light reflecting layer formed on the second insulation layer corresponding to the first to third surfaces of the heat radiating plate.

14. The backlight assembly of claim 7, wherein the heat radiating plate includes a first thermal conductivity parallel to a thickness of the heat radiating plate and a second thermal conductivity perpendicular to a thickness of the heat radiating plate, wherein the second thermal conductivity is greater than the first thermal conductivity.

15. A display device comprising:
a receiving container including a base plate and a plurality of sidewalls disposed at a peripheral area of the base plate to form a receiving space;
a light-generating module disposed in the receiving container, the light-generating module including,
a heat radiating plate including graphite,
a first insulation layer formed on the heat radiating plate,
a conductive pattern formed on the first insulation layer and receiving a driving current from an external device,
a second insulation layer covering the conductive pattern, and
a plurality of light emitting diodes mounted on the conductive pattern that is exposed through the second insulation layer;
an optical unit enhancing optical characteristics of an emitting light emitted from the light emitting diodes and outputting enhanced light; and
a display panel displaying an image based on the enhanced light emitted from the optical unit.

16. The display device of claim 15, wherein the heat radiating plate is disposed at the base plate, and the optical unit is disposed on an upper portion of the light emitting diodes.

17. The display device of claim 15, wherein the heat radiating plate comprises,
a first surface corresponding to the light emitting diodes that are disposed thereon and facing a side portion of the optical unit;
a second surface extended from the first surface, the second surface covering a portion of an exiting surface of the optical unit; and
a third surface extended from the first surface and facing the second surface, the third surface covering a portion of an opposite surface of the optical unit facing the exiting surface.

18. A method of enhancing heat radiation from a light generating module of a display device, the method comprising:
mounting a light source of the light-generating module on a heat radiating plate, the light source emitting light on a light incident surface of an optical unit of the display device;
providing a portion of the heat radiating plate parallel to the light incident surface with a first thermal conductivity in a direction perpendicular to the light incident surface of the optical unit; and,
providing the portion of the heat radiating plate parallel to the light incident surface with a second thermal conductivity in a direction parallel to the light incident surface of the optical unit, wherein the second thermal conductivity is substantially greater than the first thermal conductivity.

19. The method of claim 18, wherein the heat radiating plate includes graphite and the light source includes a light emitting diode.

20. The method of claim 18, wherein the second thermal conductivity is about 40 times greater than the first thermal conductivity.
